(19) United States
(12) Patent Application Publication
(10) Pub. No.: US 2006/0037335 A1
(43) Pub. Date: Feb. 23, 2006

(54) Method for controlling solenoid valve of air-conditioner

(75) Inventors: Chan-Ho Song, Gwacheon (KR); Yoon-Jei Hwang, Seoul (KR); Ji-Young Jang, Seongnam (KR); Jeong-Taek Park, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 10/973,307

(22) Filed: Oct. 27, 2004

(30) Foreign Application Priority Data
Aug. 20, 2004 (KR) 66064/2004

(51) Int. Cl. F25D 17/04; F25B 41/00; F25B 49/00; F25B 1/10; G05D 23/32; F25B 7/00; F25B 1/00

(52) U.S. Cl. 62/196.3; 62/510; 62/175; 62/228.5; 62/157

(57) ABSTRACT

Disclosed is a method for controlling a solenoid valve of an air-conditioner capable of reducing power consumption of an air-conditioner. To this end, in the method for controlling the solenoid valve of the air-conditioner, when at least one compressor of the air-conditioner temporarily stops operating, power is applied to a solenoid valve connected to the compressor for a preset time.

### BACKGROUND OF THE INVENTION

1. Field of the Invention

The present invention relates to an air-conditioner, and particularly, to a method for controlling a solenoid valve of an air-conditioner.

2. Description of the Prior Art

In general, an air-conditioner cools warm air of a room or heats cool air of the room. A structure of an air-conditioner having two compressors in accordance with the conventional art will now be described with reference to FIG. 1. Here, the two compressors are selectively operated according to a cooling load or a heating load of a room.

FIG. 1 is a block diagram showing a structure of an air-conditioner having two compressors in accordance with the prior art.

As shown, the air-conditioner includes first and second compressors 11 and 12 having different compressing capacities and compressing a refrigerant into a high temperature high pressure gaseous refrigerant; an outdoor heat exchanger 14 allowing the refrigerant to exchange its heat with the outdoor air to thereby condense the refrigerant into a moderate temperature high pressure liquid refrigerant; an outdoor fan 14A cooling down heat of the outdoor heat exchanger 14; an electronic expansion valve 15 changing the refrigerant having passed through the outdoor heat exchanger 14 into a low temperature low pressure liquid refrigerant; an indoor heat exchanger 16 allowing the refrigerant having passed through the electronic expansion valve 15 to exchange its heat with the indoor air; an indoor fan 16A discharging the air to the indoor heat exchanger 16; and an accumulator 17 supplying the refrigerant (gaseous refrigerant) having passed through the indoor heat exchanger 16 to the first and second compressors 11 and 12.

In addition, the air-conditioner having two compressors further includes check valves 11A and 12A preventing back flow of the refrigerant compressed by the first and second compressors 11 and 12; a four-way valve 13 switching a channel of the refrigerant having passed through the first and second compressor 11 and 12. Namely, when the air-conditioner is in a cooling mode, a refrigerant discharged from the two compressors 11 and 12 passes through the check valves 11A and 12A and is condensed in the outdoor heat exchanger 14. Then, the refrigerant passes through the electronic expansion valve 15, is evaporated in the indoor heat exchanger 16, and then is circulated to the first and second compressors 11 and 12 via the accumulator 17.

Meanwhile, to achieve balanced internal pressure of the first and second compressors 11 and 12 (inlet pressure and outlet pressure of the compressor), solenoid valves are formed at the first and second compressors 11 and 12, respectively. The solenoid valves connected to the compressors 11 and 12 will now be described with reference FIG. 2.

FIG. 2 is a view showing solenoid valves respectively installed at compressors of the air-conditioner in accordance with the prior art.

As shown in FIG. 2, in order to balance the internal pressure of the first compressor 11 or the second compressor 12 when the first compressor 11 or the second compressor 12 does not operate, solenoid valves 11B and 12B are connected to pipes installed at inlets of the first and second compressors 11 and 12 and to pipes installed at outlets of the first and second compressors 11 and 12, respectively.

The operation of the solenoid valves 11B and 12B will now be described with reference to FIG. 3.

FIG. 3 is a view showing a waveform of a control signal for controlling the compressor and the solenoid valve of the air-conditioner in accordance with the prior art.

As shown, when the first compressor 11 or the second compressor 12 of the air-conditioner stops operating, power is applied to the solenoid valves 11B and 12B for a time for which the first compressor 11 or the second compressor 12 stops operating, to thereby open the solenoid valves 11B and 12B. By such opening, the internal pressure of the first compressor 11 or the second compressor 12 is balanced.

However, the air-conditioner in accordance with the conventional art is disadvantageous in that power consumption of the air-conditioner is increased because even in case that the first compressor 11 or the second compressor 12 stops operating for a long time, power is unnecessarily applied to the solenoid valve for the long time. For example, if the compressor (first or second compressor) stops operating for ten minutes, the air-conditioner in accordance with the conventional art provides power to the solenoid valve for ten minutes. At this time, although the balanced internal pressure of the compressor can be maintained only with two minutes of opening of the solenoid valve, power is supplied to the solenoid valve for ten minutes, causing a power consumption increase of the air-conditioner. Namely, by unnecessarily applying power to the solenoid valve for eight minutes, the power consumption of the air-conditioner is increased.

Meanwhile, an air-conditioner in accordance with the conventional art is disclosed in U.S. Pat. No. 6,519,957 issued on Feb. 18, 2003.

### SUMMARY OF THE INVENTION

Therefore, an object of the present invention is to provide a method for controlling a solenoid valve of an air-conditioner capable of reducing power consumption of an air-conditioner by applying power to a solenoid valve of the air-conditioner when a time for which a compressor of the air-conditioner stops operating passes a predetermined time.

Another object of the present invention is to provide a method for controlling a solenoid valve of an air-conditioner capable of reducing power consumption of the air-conditioner by applying power to the solenoid valve of the air-conditioner for a preset time whenever a compressor of the air-conditioner temporarily stops operating.

To achieve these and other advantages and in accordance with the purpose of the present invention, as embodied and broadly described herein, there is provided a method for controlling a solenoid valve of an air-conditioner comprising: a step in which when at least one compressor of the air-conditioner temporarily stops operating, power is applied to a solenoid valve connected to the compressor for a preset time.

To achieve these and other advantages and in accordance with the purpose of the present invention, as embodied and broadly described herein, there is provided a method for controlling a solenoid valve of an air-conditioner comprising: measuring a stop time of the compressor when at least one compressor of the air-conditioner temporarily stops operating; and applying power to a solenoid valve connected to the compressor when the measured stop time passes a preset time.

To achieve these and other advantages and in accordance with the purpose of the present invention, as embodied and broadly described herein, there is provided a method for controlling a solenoid valve of an air-conditioner comprising: applying power to solenoid valves connected to compressors of an air-conditioner only for a preset time when the compressors temporarily stop operating, so that power consumption of the solenoid valves connected to the compressors of the air-conditioner is reduced.

To achieve these and other advantages and in accordance with the purpose of the present invention, as embodied and broadly described herein, there is provided a method for controlling a solenoid valve of an air-conditioner comprising: a step in which when a stop signal for stopping at least one compressor installed at the air-conditioner is generated, the compressor is stopped; and a step in which when the stop time of the compressor passes a first preset time, at least one solenoid valve connected to the compressor is opened.

To achieve these and other advantages and in accordance with the purpose of the present invention, as embodied and broadly described herein, there is provided a method for controlling a solenoid valve of an air-conditioner including a first compressor and a second compressor for compressing a refrigerant; solenoid valves respectively connected to the first compressor and the second compressor to balance internal pressure of the first compressor and the second pressure, comprising: stopping the first compressor or the second compressor when a first stop signal for stopping the first compressor or the second compressor is generated; applying power to the solenoid valve connected to the first compressor or the second compressor when a time for which the first compressor or the second compressor stops operating passes a first preset time; stopping the first compressor and the second compressor when a second stop signal for simultaneously stopping the first compressor and the second compressor is generated; and cutting off power applied to the solenoid valves when a time for which the first compressor and the second compressor simultaneously stop operating passes a second preset time.

To achieve these and other advantages and in accordance with the purpose of the present invention, as embodied and broadly described herein, there is provided A method for controlling a solenoid valve of an air-conditioner including a first compressor and a second compressor for compressing a refrigerant; and solenoid valves respectively connected to the first compressor and the second compressor to balance internal pressure of the first compressor and the second compressor, comprising: stopping the first compressor or the second compressor when a first stop signal for stopping the first compressor or the second compressor is generated; applying power to the solenoid valve connected to the first compressor or the second compressor when a time for which the first compressor or the second compressor stops operating passes a first preset time; and cutting off power applied to the solenoid valves when a time for which the first compressor or the second compressor stops operating passes a second preset time after the power is applied to the solenoid valve connected to the first compressor or the second compressor, wherein, the first preset time is a time obtained by subtracting the time required to balance inlet pressure and outlet pressure of the first compressor or the second compressor from a minimum stop time for which the first compressor and the second compressor temporarily stops operating, and the second preset time is a minimum stop time for which the first compressor or the second compressor temporarily stops operating.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a unit of this specification, illustrate embodiments of the invention and together with the description serve to explain the principles of the invention.

In the drawings:

FIG. 1 is a block diagram showing a structure of an air-conditioner having two compressors in accordance with the prior art;

FIG. 2 is a view showing solenoid valves respectively installed at compressors of the air-conditioner in accordance with the prior art;

FIG. 3 is a view showing a waveform of a control signal for controlling a compressor and a solenoid valve of the air-conditioner in accordance with the prior art;

FIG. 4 is a flow chart showing a method for controlling a solenoid valve of an air-conditioner in accordance with an embodiment of the present invention; and

FIG. 5 is a view showing a waveform of a control signal for controlling a compressor and a solenoid valve of the air-conditioner in accordance with the present invention.

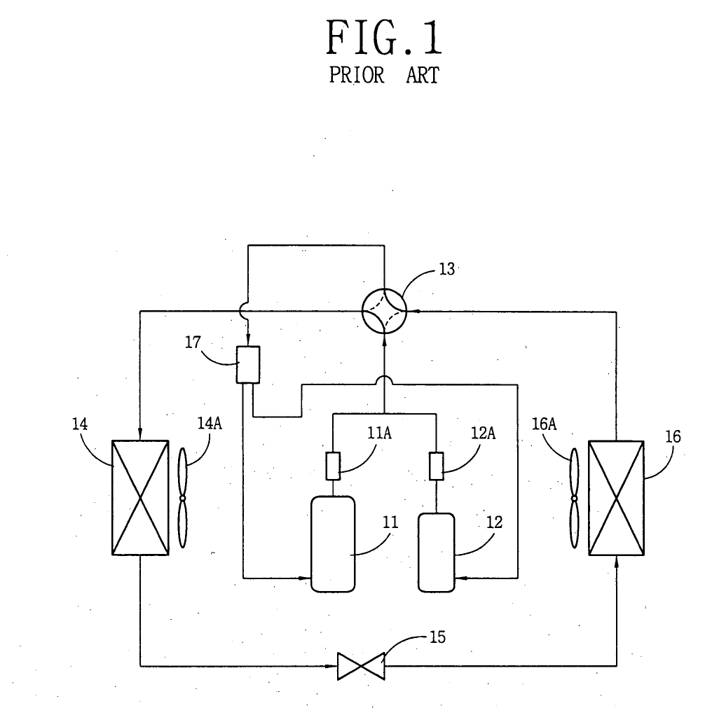

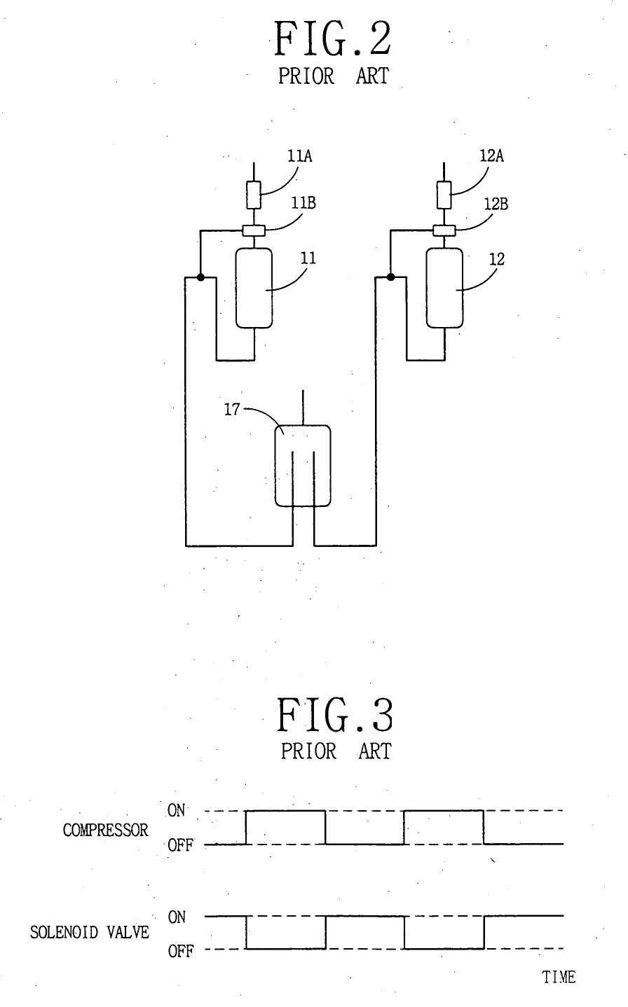

### DETAILED DESCRIPTION OF THE PREFERRED EMBODIMENTS

Reference will now be made in detail to the preferred embodiments of the present invention, examples of which are illustrated in the accompanying drawings.

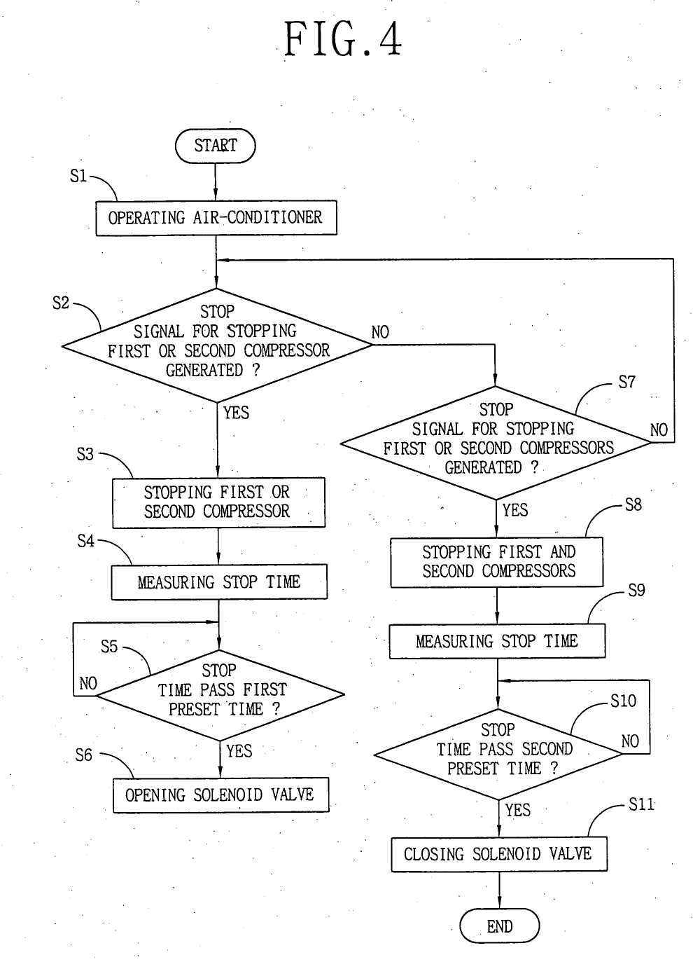

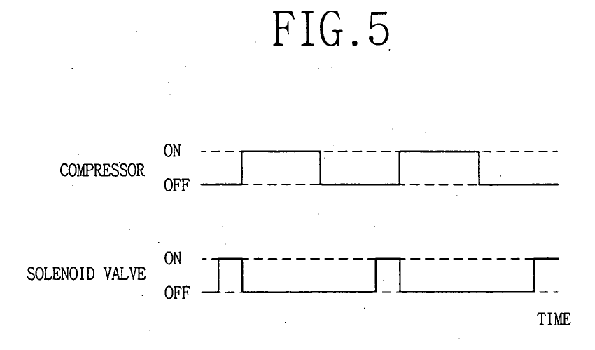

A preferred embodiment of a method for controlling a solenoid valve of an air-conditioner to reduce power consumption of the air-conditioner will now be described with reference to FIGS. 4 and 5. Here, because compressors and solenoid valves in accordance with the present invention have the same structure as that of the conventional art, reference numbers of the compressors and the solenoid valves will be omitted.

FIG. 4 is a flow chart showing a method for controlling a solenoid valve of an air-conditioner in accordance with an embodiment of the present invention. Here, the solenoid valves are connected to inlet pipes and outlet pipes of a small capacity compressor and a large capacity compressor, respectively, to balance internal pressure of the small capacity compressor and the large capacity compressor.

As shown, the method for controlling a solenoid valve of the air-conditioner in accordance with the present invention comprises: stopping a small capacity compressor or a large capacity compressor installed in the air-conditioner when a stop signal for stopping the small capacity compressor or the large capacity compressor is generated; balancing the internal pressure of the small capacity compressor or the large capacity compressor by applying power to the solenoid valve connected to the small capacity compressor or the large capacity compressor when a time for which the small capacity compressor or the large capacity compressor stops operating passes a first preset time.

Here, preferably, the first preset time is preferably obtained by subtracting the time required to balance inlet pressure and outlet pressure of the compressor from a minimum stop time for which the compressor (small capacity compressor or large capacity compressor) temporarily stops operating while the air-conditioner is in operation. For example, if the minimum stop time for which the compressor temporarily stops operating in operation of the air-conditioner is seven minutes and the time required to balance the inlet pressure and the outlet pressure of the compressor is two minutes, preferably, the first preset time is set to be five minutes (7 min.−2 min.=5 min.). Namely, in the present invention, on the assumption that the compressor temporarily stops operating for seven minutes at the minimum and then reoperates, when the stop time of the compressor passes five minutes (first preset time), power is applied to the solenoid valve connected to the compressor only for two minutes, thereby reducing power consumption of the air-conditioner. Namely, because power is not applied to the solenoid valve for five minutes, the power consumption of the air-conditioner (solenoid valve) is reduced.

In addition, a method for controlling a solenoid valve of an air-conditioner in accordance with the present invention further includes: simultaneously stopping the small capacity compressor and the large capacity compressor when a stop signal for simultaneously stopping the small capacity compressor and the large capacity compressor is generated; and cutting off power supplied to the solenoid valves when the time for which the small capacity compressor and the large capacity compressor simultaneously stop operating passes a second preset time. That is, in the present invention, power applied to the solenoid valves is cut off when all compressors do not reoperate but continuously maintains their stopped state although all compressors of the air-conditioner stops operating for longer than the second preset time (e.g., seven minutes), thereby further reducing the power consumption of the air-conditioner (solenoid valve).

Hereinafter, the method for controlling the solenoid valve of the air-conditioner in accordance with the present invention will now be described in detail with reference to FIG. 4.

First, when the air-conditioner is operated with its mode changed to a cooling mode or a heating mode (S1), the air-conditioner separately or simultaneously drives a small capacity compressor and a large capacity compressor according to a heating load or a cooling load or simultaneously drives the compressors. At this time, when the air-conditioner operates in the cooling mode or the heating mode, a control unit (not shown) of the air-conditioner determines whether a first stop signal for temporarily stopping the small capacity compressor or the large capacity compressor is generated according to the heating load or the cooling load (S2).

Thereafter, if a first stop signal for stopping the small capacity compressor (or large capacity compressor) is generated, the control unit stops the small capacity compressor (or large capacity compressor) (S3) and then measures how long the small capacity compressor has been stopped (S4).

When the measured stop time passes a first preset time (S5), the control unit applies power to the solenoid valve installed at the small capacity compressor to open the solenoid valve and thus balance the internal pressure of the small capacity compressor (S6). Here, the first preset time may be varied depending on a kind of compressor and a compressing capacity.

Thereafter, if the compressor of the air-conditioner operates, the control unit cuts off power applied to the solenoid valve. At this time, the air-conditioner separately or simultaneously operates a small capacity compressor and a large capacity compressor according to a control signal (e.g., a control signal of a thermostat (not shown) of the air-conditioner). Namely, if one of the small capacity compressor and the large capacity compressor is operated, the control unit cuts off power supplied to the solenoid valve installed at the operated compressor to thereby close the solenoid valve.

Here, when the stop time passes the first preset time, the control unit applies power to a solenoid valve connected to one of the small capacity compressor and the large capacity compressor. Then, if the compressor does not operate even though the stop time of the compressor passes the second preset minutes (e.g., seven minutes), the control unit cuts off power applied to the solenoid valve.

Meanwhile, in the step (S2) of determining whether a first stop signal for stopping the small capacity compressor or the large capacity compressor is generated according to the heating load or the cooling load, if the first stop signal is not generated, the control unit (not shown) of the air-conditioner determines whether a second stop signal for simultaneously stopping the small capacity compressor and the large capacity compressor is generated (S7).

The control unit simultaneously stops the small capacity compressor and the large capacity compressor based on the second stop signal (S8).

Thereafter, the control unit measures how long the small capacity compressor and the large capacity compressor have been simultaneously stopped (S9), and when the measured stop time passes the second preset time (S10), power supplied to each solenoid valve is cut off to reduce power consumption of each solenoid valve (S11). Here, the second preset time means a minimum operation stop time (e.g., seven minutes) for which the compressor stops operating while the air-conditioner is in operation. For example, if the small capacity compressor and the large capacity compressor simultaneously stop operating, the control unit applies power to each solenoid valve after the first preset time elapses, to thereby balance the internal pressure of the small capacity compressor and the large capacity compressor and maintain the balanced internal pressure. Then, when the time for which the small capacity compressor and the large capacity compressor simultaneously stop operating passes the second preset time (e.g., seven minutes), the control unit recognizes that the air-conditioner is forcedly stopped by a user and cuts off power supplied to each solenoid valve.

FIG. 5 is a view showing a waveform of a control signal for controlling a compressor and a solenoid valve of an air-conditioner in accordance with an embodiment of the present invention.

As shown, in the method for controlling a solenoid valve of the air-conditioner in accordance with the present invention, power is not applied to the solenoid valve as soon as the compressor (small capacity compressor and/or large capacity compressor) stops operating. But, the power is applied to the solenoid valve and opens the solenoid valve when the first preset time (e.g., five minutes) elapses, so that the power consumption of the air-conditioner (solenoid valve) is reduced.

In addition, when a time for which all compressors of the air-conditioner simultaneously stop operating passes a second preset time, power applied to the solenoid valves is cut off and closes the solenoid valve, so that the power consumption of the air-conditioner (solenoid valve) is additionally reduced.

Meanwhile, in the present invention, the power consumption of the air-conditioner may be reduced by applying power to the solenoid valve only for a preset time (e.g., for two minutes) whenever the air-conditioner temporarily stops operating.

As so far described, in the method for controlling a solenoid valve of the air-conditioner in accordance with the present invention, when a temporary stop time of at least one compressor of the air-conditioner passes a preset time, power is applied to a solenoid valve connected to the compressor, thereby reducing power consumption of the air-conditioner.

In addition, in the method for controlling a solenoid valve of the air-conditioner in accordance with the present invention, whenever at least one compressor of the air-conditioner temporarily stops operating, power is applied to a solenoid valve of the compressor only for a preset time, thereby reducing power consumption of the air-conditioner.

Also, in the method for controlling a solenoid valve of the air-conditioner in accordance with the present invention, when a time for which all compressors of the air-conditioner stop operating passes a preset time, power applied to the solenoid valves is cut off, thereby additionally reducing power consumption.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method for controlling a solenoid valve of an air-conditioner comprising:
a step in which when at least one compressor of the air-conditioner temporarily stops operating, power is applied to a solenoid valve connected to the compressor for a preset time.

2. The method of claim 1, further comprising:
cutting off power applied to the solenoid valve when the compressor operates.

3. A method for controlling a solenoid valve of an air-conditioner comprising:
measuring a stop time of the compressor when at least one compressor of the air-conditioner temporarily stops operating; and
applying power to a solenoid valve connected to the compressor when the measured stop time passes a preset time.

4. The method of claim 3, further comprising:
cutting off power applied to the solenoid valve when the compressor operates.

5. A method for controlling a solenoid valve of an air-conditioner comprising:
applying power to solenoid valves connected to compressors of an air-conditioner only for a preset time when the compressors temporarily stop operating, so that power consumption of the solenoid valves connected to the compressors of the air-conditioner is reduced.

6. The method of claim 5, further comprising:
cutting off power applied to the solenoid valves when the compressors operate.

7. A method for controlling a solenoid valve of an air-conditioner comprising:
a step in which when a stop signal for stopping at least one compressor installed at the air-conditioner is generated, the compressor is stopped; and
a step in which when a stop time of the compressor passes a first preset time, at least one solenoid valve connected to the compressor is opened.

8. The method of claim 7, further comprising:
closing the solenoid valve when the stop time passes a second preset time.

9. The method of claim 8, wherein the closing of the solenoid valve comprises:
cutting off power applied to the solenoid valve when the stop time passes the second preset time.

10. The method of claim 7, wherein the opening of the solenoid valve comprises:
applying power to the solenoid valve when the stop time of the compressor passes the first preset time.

11. The method of claim 7, further comprising:
cutting off power applied to the solenoid valve when the compressor operates.

12. The method of claim 7, wherein the solenoid valve is installed at the compressor in order to balance inlet pressure and outlet pressure of the compressor.

13. The method of claim 7, wherein the first preset time is obtained by subtracting the time required to balance the inlet pressure and the outlet pressure of the compressor from a minimum stop time for which the compressor stops operating while the air-conditioner is in operation.

14. The method of claim 8, wherein the second preset time is a minimum stop time for which the compressor stops operating while the air-conditioner is in operation.

15. The method of claim 8, wherein the first preset time is shorter than the second preset time.

16. A method for controlling a solenoid valve of an air-conditioner including a first compressor and a second compressor for compressing a refrigerant; solenoid valves respectively connected to the first compressor and the second compressor to balance internal pressure of the first compressor and the second pressure, comprising:
stopping the first compressor or the second compressor when a first stop signal for stopping the first compressor or the second compressor is generated;
applying power to the solenoid valve connected to the first compressor or the second compressor when a time for which the first compressor or the second compressor stops operating passes a first preset time;
stopping the first compressor and the second compressor when a second stop signal for simultaneously stopping the first compressor and the second compressor is generated; and
cutting off power applied to the solenoid valves when a time for which the first compressor and the second compressor simultaneously stop operating passes a second preset time.

17. The method of claim 16, further comprising closing the solenoid valve by cutting off power applied to the solenoid valve connected to the first compressor or the second compressor when the first compressor and the second compressor operate.

18. The method of claim 17, wherein the first preset time is a time obtained by subtracting the time required to balance inlet pressure and outlet pressure of the first compressor or the second compressor from a minimum stop time for which the first compressor or the second compressor stops operating while the air-conditioner is in operation.

19. The method of claim 17, wherein the second preset time is a minimum stop time for which the first compressor or the second compressor temporarily stops operating while the air-conditioner is in operation.

20. A method for controlling a solenoid valve of an air-conditioner including a first compressor and a second compressor for compressing a refrigerant; and solenoid valves respectively connected to the first compressor and the second compressor to balance internal pressure of the first compressor and the second compressor, comprising:
stopping the first compressor or the second compressor when a first stop signal for stopping the first compressor or the second compressor is generated;
applying power to the solenoid valve connected to the first compressor or the second compressor when a time for which the first compressor or the second compressor stops operating passes a first preset time; and
cutting off power applied to the solenoid valves when a time for which the first compressor or the second compressor stops operating passes a second preset time after the power is applied to the solenoid valve connected to the first compressor or the second compressor,
wherein, the first preset time is a time obtained by subtracting the time required to balance inlet pressure and outlet pressure of the first compressor or the second compressor from a minimum stop time for which the first compressor and the second compressor temporarily stops operating, and the second preset time is a minimum stop time for which the first compressor or the second compressor temporarily stops operating.
